(19) United States
(12) Patent Application Publication
(10) Pub. No.: US 2015/0277597 A1
(43) Pub. Date: Oct. 1, 2015

(54) TOUCHPAD HAND DETECTOR

(71) Applicant: HandScape Inc., Mountain View, CA (US)

(72) Inventor: Tong Luo, Fremont, CA (US)

(21) Appl. No.: 14/671,738

(22) Filed: Mar. 27, 2015

Related U.S. Application Data
(60) Provisional application No. 61/972,022, filed on Mar. 28, 2014.

(51) Int. Cl. G06F 3/0354; G06F 1/16; G06F 3/038

(52) U.S. Cl. CPC G06F 3/03547; G06F 3/038; G06F 1/169

(57) ABSTRACT

An electronic device includes a housing, a touchpad at a first surface of the housing, and at least one first electrode adapted to transmit a first signal to a first hand of a user when the user holds the housing with the first hand. The electronic device further includes a circuit adapted to detect the first signal when the touchpad receives a first input from the first hand. The first signal is coupled from the first electrode to the touchpad via the first hand.

### CROSS-REFERENCES TO RELATED APPLICATIONS

This application claims priority, under 35 U.S.C. §119(e), to U.S. Provisional Patent Application No. 61/972,022, entitled, “TOUCHPAD HAND DETECTOR,” inventor Tong Luo, filed Mar. 28, 2014, which is incorporated herein by reference in its entirely for all purposes. This application is related to U.S. Pat. No. 8,384,683 B2, filed on May 4, 2010, entitled “Method for User Input From the Back Panel of a Handheld Computerized Device,” U.S. patent application Ser. No. 13/223,836, filed on Sep. 1, 2011, entitled “Detachable Back Mounted Touchpad for a Handheld Computerized Device”, U.S. patent application Ser. No. 13/770,791, filed on Feb. 19, 2013, entitled “Method for User Input From Alternative Touchpads of a Handheld Computerized Device”, and U.S. Provisional Patent Application No. 61/916,168, filed on Dec. 14, 2013, entitled “Method for User Input From Alternative Touchpads of a Handheld Computerized Device,” which are incorporated herein by reference in their entirety for all purposes.

### BACKGROUND OF THE INVENTION

The present disclosure generally relates to handheld computerized devices and more particularly to techniques for user interaction with handheld computerized devices.

Handheld computerized devices typically include devices including microprocessors and sophisticated displays) such as cell phones, personal digital assistants (PDA), game devices, tabletPCs, such as the iPad®, wearable computerized devices, and the like. These devices play an increasingly important role in everyday life and are becoming more and more indispensable. With the advancement of technology and improvements in processing power of handheld computerized devices, the functionality and memory space of these devices has considerably increased. Additionally, the size of these devices has considerably reduced making interaction on displays of such devices more challenging.

To meet the challenges of smaller device displays, handheld computerized devices may make use of keyboard keys that are smaller in size. For example, keys may be assigned multiple and complex functions (i.e. are overloaded). In some instances, handheld computerized devices may use touch screen keyboards, or “soft keys”, on the front panel. Here a user may use a stylus pen or finger to select a soft key through a graphical user interface. However due to optical illusions introduced by the display screen and the fact that the user's fingers are often on top of the soft keys, the user's fingers may often block the user from directly viewing the keys, especially if the soft keys are relatively small. In addition, having small soft keys may result in a single finger press activating multiple keys. In some cases, soft keys displayed by handheld computerized devices may be typically designed by dividing the keys into different groups and hierarchies and displaying a small number of keys at any given time on the screen. In some cases, the user input area may occupy a significant portion of the front panel of the handheld computerized device and the user input process may require a relatively large amount of user attention to operate which may typically be error prone. As such, finding improved techniques for user interaction with handheld computerized devices continues to be a priority.

### BRIEF SUMMARY OF THE INVENTION

Techniques are disclosed by which a particular hand (e.g., left hand or right hand) of a user may be detected and/or identified when the user interacts with a handheld computerized device. Identifying a particular hand of a user interacting with a device enables improved user interaction with the device. For instance, the disclosed technique may enable complex graphics on the display screen of the handheld electronic device to be displayed in a particular manner based on the identification and/or detection of a particular hand of the user interacting with the device.

According to one embodiment of the present invention, an electronic device is disclosed. In some examples, the electronic device may be a handheld computerized device. The electronic device includes a housing and a touchpad located at a first surface of the housing. The electronic device further includes at least one first electrode adapted to transmit a first signal to a first hand of a user when the user holds the housing with the first hand and a circuit adapted to detect the first signal when the touchpad receives a first input from the first hand. In some embodiments, the first signal is coupled from the first electrode to the touchpad via the first hand.

In some embodiments, the touchpad may be adapted to receive the first input when the user touches the touchpad using the first hand. In other embodiments, the touchpad may be adapted to receive the first input when the user hovers a finger of the first hand at a predetermined distance from the touchpad.

In some embodiments, the circuit may be adapted to detect a second signal. In an example, the second signal may include a change in a characteristic of the first signal when the touchpad receives a second input from a second hand when the user holds the housing with the second hand. In some examples, the second signal may be electrically coupled from the first electrode to the touchpad via the second hand.

In some examples, the first signal is a time invariant electrical source or a time variant signal. In some examples, the first surface includes a first end, wherein the first electrode is disposed in proximity to the first end. In some examples, the first electrode is disposed on a wearable device.

In some embodiments, the electronic device may include a second electrode. In some examples, the second electrode may be different from the first electrode and adapted to transmit a second signal different from the first signal to a second hand of the user different from the first hand when the user holds the housing with the second hand. In some examples, the circuit may be further adapted to detect the second signal when the touchpad receives a second input from the second hand. In some examples, the second signal is electrically coupled from the second electrode to the touchpad via the second hand.

In certain examples, the first surface includes a first end and a second end different from the first end and substantially parallel to the first end, wherein the first electrode is disposed in proximity to the first end and the second electrode is disposed in proximity to the second end. In some examples, the circuit is further adapted to determine when the touchpad receives the first input from a finger of the first hand or when the touchpad receives the second input from a finger of the second hand.

According to one embodiment of the present invention, a method for electrically detecting a first hand of a user at an electronic device including a housing and a touchpad at a first surface of the housing is disclosed. In some embodiments, the method may include transmitting a first signal from at least one first electrode to the first hand of the user when the user holds the housing with the first hand. The method may further include detecting the first signal with a circuit when the touchpad receives a first input from the first hand. In some examples, the first signal is coupled from the first electrode to the touchpad via the first hand.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 depicts a simplified perspective view of an exemplary handheld electronic device for electrically detecting a left hand of a user operating an electronic device, in accordance with one embodiment of the present invention.

FIG. 2 depicts a simplified perspective view of an exemplary handheld electronic device and wearable electronic device for electrically detecting a hand of a user operating the handheld electronic device, in accordance with one embodiment of the present invention.

FIG. 3 depicts a simplified perspective view of the handheld electronic device depicted in FIG. 1 for electrically detecting the left hand and a right hand of the user, in accordance with one embodiment of the present invention.

FIG. 4 depicts a simplified side view of the handheld electronic device depicted in FIG. 1 and FIG. 3, in accordance with one embodiment of the present invention.

FIG. 5A depicts a simplified side view of the handheld electronic device depicted in FIG. 1 and FIG. 3 and a detachable housing, in accordance with one embodiment of the present invention.

FIG. 5B depicts a simplified side view of the handheld electronic device depicted in FIG. 5A, in accordance with one embodiment of the present invention.

FIG. 5C depicts a simplified side view of the housing depicted in FIG. 5A with the housing flipped over, in accordance with one embodiment of the present invention.

FIG. 6 depicts a simplified schematic diagram of a touchpad hand detector circuit included in the devices depicted in FIG. 3 using a multitude of time invariant electrical signal sources, in accordance with one embodiment of the present invention.

FIG. 7 depicts a simplified schematic diagram of a touchpad hand detector circuit included in the devices depicted in FIG. 3 using a multitude of time variant signal sources, in accordance with one embodiment of the present invention.

FIG. 8 depicts a simplified schematic diagram of a touchpad hand detector circuit included in the devices depicted in FIG. 3 using a time variant signal source, in accordance with one embodiment of the present invention.

FIG. 9 depicts a simplified schematic diagram of a touchpad hand detector circuit included in the devices depicted in FIG. 3 using a time variant ultrasonic signal source, in accordance with one embodiment of the present invention.

FIG. 10 depicts a simplified schematic diagram of a touchpad hand detector circuit included in the devices depicted in FIG. 3 using a time variant signal source being used by a first user and no signal being used by a second user different than the first user, in accordance with one embodiment of the present invention.

FIG. 11 depicts a simplified schematic diagram of the touch analyzer depicted in FIGS. 6-10, in accordance with one embodiment of the present invention.

FIG. 12 depicts a simplified schematic diagram of the comparator depicted in FIG. 11, in accordance with one embodiment of the present invention.

FIG. 13 depicts a simplified flowchart for detecting a first hand of a user at an electronic device depicted in FIG. 1, in accordance with one embodiment of the present invention.

FIG. 14 depicts a simplified flowchart for detecting the first signal depicted in FIG. 13, in accordance with one embodiment of the present invention.

### DETAILED DESCRIPTION

In the following description, for the purposes of explanation, specific details are set forth in order to provide a thorough understanding of embodiments of the invention. However, it will be apparent that various embodiments may be practiced without these specific details. The figures and description are not intended to be restrictive.

Embodiments of the present invention relate to a handheld computerized device that includes a bit mapped display screen on the front panel and a touchpad installed on the back panel, side panel, or other area other than the display screen. In some embodiments, the handheld computerized device may be configured to display a real time position and motion of a user's fingers that hold the device, which normally would be hidden from view by the device itself, to be displayed on the display screen as “virtual fingers” together with an optional display of a virtual keyboard layout. The user's finger positions and keyboard layout may be displayed either as a background image, or as a transparent layer on top of some or all of the applications currently running on the handheld device. These semi-transparent representations of the user's finger positions and virtual keyboard allow the user to easily enter data while, at the same time, continuing to allow the user unimpeded access to the various applications running on the handheld device.

In some embodiments, the handheld computerized device may include a display screen on the front panel, which may be a bit-mapped display screen, a touchpad embedded on the back panel capable of sensing the user's finger positions and motion, and a graphical user interface. The graphical user interface may include both software and optional graphics acceleration hardware to enable complex graphics to be rapidly displayed on the display screen. The device may also include a virtual keyboard processor that displays a virtual keyboard layout, as well as computes and displays a user's virtual finger positions on a real-time basis. In some embodiments, the user's finger position and motion on the touchpad on the back panel may be computed and displayed on the front display screen as a layer, which may be a semi-transparent layer, on top of all of the other applications. The virtual keyboard processor may also interpret the finger motions, i.e. strokes, and invoke corresponding operations based on the known locations of the finger position on the keyboard.

In accordance with some embodiments, a method is disclosed to identify and/or detect a particular hand of a user (e.g., left or right) providing input when the user interacts with the handheld computerized device. In some embodiments, the disclosed technique enables a position of virtual keys displayed on the display screen to be determined with greater accuracy based on identifying a particular hand of the user providing input. For instance, the disclosed technique may enable a virtual keyboard processor displayed on the display screen of the handheld computerized device to position virtual keys in a virtual keyboard layout that are typically struck by a left hand or a right hand of a user more accurately on the display screen based on identifying whether a left hand or a right hand of the user is providing input on the touchpad. For instance, users may typically use the right index finger to type a certain set of keys (e.g., “H” and “J”) and use the left pinky finger to type the letter's “A” and “Z”. In certain embodiments, the disclosed technique may enable virtual keys such as H″ and “J” to be positioned, for example, on an upper right-hand corner of the display screen and virtual keys such as “A” and “Z” to be positioned, for example, on a lower left-hand corner of the display screen, based on identifying which hand of the user is providing the input.

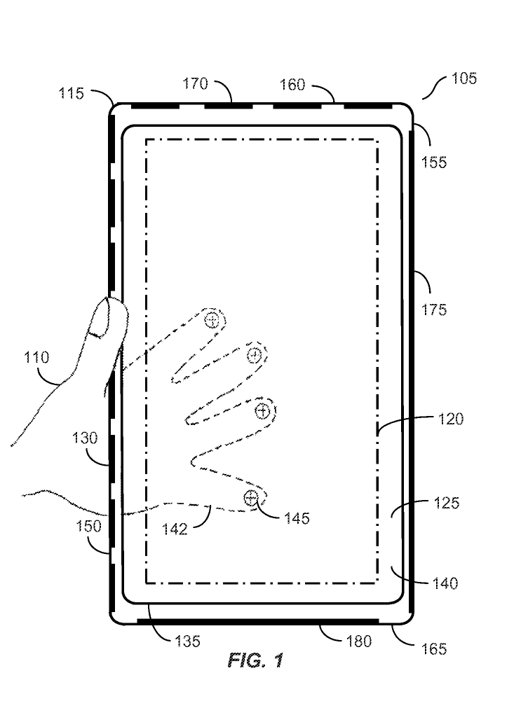

FIG. 1 depicts a simplified perspective view of an exemplary handheld electronic device 105 for electrically detecting a left hand 110 of a user operating electronic device 105, in accordance with one embodiment of the present invention. Handheld electronic device 105 may include a housing 115, and a touchpad 120 depicted as a dot-dashed line at a backside surface 125 of housing 115. Handheld electronic device 105 may further include at least one first electrode 130 adapted to transmit a left signal to left hand 110 when the user holds housing 115 with left hand 110. Handheld electronic device 105 may further include a circuit adapted to detect the left signal when touchpad 120 receives a first input from left hand 110. The left signal may be coupled from first electrode 130 to touchpad 120 via left hand 110.

In one embodiment, handheld electronic device 105 may further include a display screen 135 at a front side surface 140 of housing 115. FIG. 1 depicts handheld electronic device 105 from the user's perspective that is when the user is directly viewing display screen 135 and front side surface 140. Locating touchpad 120 on the back side of housing 115 may provide many advantages, such as for example, enabling the user's hand and/or fingers to be placed such that little if any obstruction is created by the user's hand and/or fingers to images displayed on display screen 135. However, the user may not be able to see the position of the hand and/or fingers relative to control input icons or virtual alphanumeric typing keys displayed on display screen 135 because handheld electronic device 105, housing 115 and/or display screen 135 may not be visually transparent to the user. The lack of transparency may make user inputs on touchpad 120 difficult because the locations of the user's fingers are obstructed from the user such that guiding the fingers to particular input locations on touchpad 120 or associated locations on display screen 135 may be difficult.

Thus, in some embodiments, electronic device 105 may be configured to display a virtual image 142 of the user's left hand 110 and/or a virtual image of one or more touchpad left input 145 on display screen 135 to enable the user to see the finger position and/or touch inputs superimposed as a shadow, outline, or see-through image over the normal information being displayed. The manner in which electronic device 105 may be configured to display a virtual image of the user's hand is described, for example, in U.S. Pat. No. 8,384,683, the contents of which are incorporated herein by reference in its entirety. In some embodiments, and as will be discussed in detail below, the device is configured to register which hand of the user, i.e. left or right hand, is providing input at touchpad 120 in order to better model the virtual finger positions of the user with greater accuracy, less computational overhead, better reliability, and/or faster speed.

In some aspects, handheld electronic device 105 may determine that the hand touching handheld electronic device 105 is left hand 110 because first electrode 130 is transmitting the left signal that is received when touchpad 120 receives an input from left hand 110. Because each hand of the user may have certain structural attributes that differentiate between left hand and right hand, from the user's perspective, the definition of left hand and right hand are unambiguous and understood. Further, the left signal may be applied by handheld electronic device 105 to first electrode 130 because, in the depicted example, handheld electronic device 105 may be displaying images oriented on display screen 135 such that images that are to be displayed at the left end of display screen 135, as viewed from the perspective of the user, are closer to a first end 150 of backside surface 125 than to any other end of backside surface 125. In other words, the handheld electronic device 105 may determine what end of backside surface 125 may be associated with left signal transmission in accordance with the orientation of images displayed on display screen 135.

In one embodiment, backside surface 125 may include four ends each one listed in the following clockwise rotation order from the perspective of the user's direct view of display screen 135 and front side surface 140; a first end 150, a third end 160 located substantially perpendicular to first end 150, a second end 155 substantially parallel to first end 150, and a fourth end 165 located substantially perpendicular to first end 150. For purposes of this document, the term ‘substantially’ refers to normal manufacturing tolerances applicable to handheld electronic devices. In one embodiment, first electrode 130 may be disposed in proximity to first end 150. In another embodiment, first electrode 130 may include a multitude of electrodes 130 disposed in proximity to first end 150. By being in proximity, it is understood that electrode or multitude of electrodes 130 may be disposed between first end 150 and display screen 135 on front side surface 140 or between first end 150 and touchpad 120 on back side surface 125.

In one embodiment, handheld electronic device 105 may further include a at least one third electrode 170 disposed in proximity to third end 160, a second electrode 175 disposed in proximity to second end 155, and a fourth electrode 180 disposed in proximity to bottom end 165. In some embodiments, a multitude of electrodes may be replaced with a single electrode and a single electrode may be replaced with a multitude of electrodes without affecting the function of handheld electronic device 105.

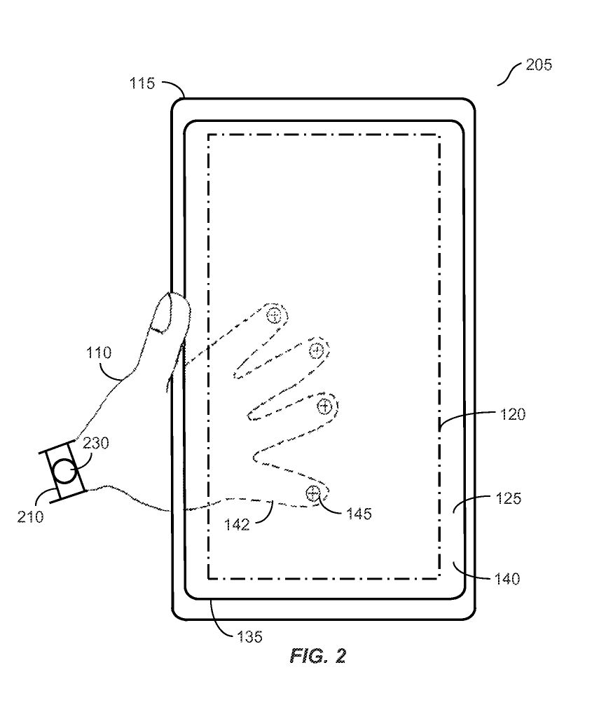

FIG. 2 depicts a simplified perspective view of an exemplary handheld electronic device 205 and an exemplary wearable electronic device 210 for electrically detecting hand 110 of the user at handheld electronic device 205, in accordance with one embodiment of the present invention. Handheld electronic device 205 may include features similar to handheld electronic device 105 depicted in FIG. 1 except that handheld electronic device 205 may not have electrodes 130, 170, 175, 180 disposed at housing 115. Instead, in the embodiment depicted in FIG. 2, first electrode 230 may be disposed on wearable electronic device 210. For example, wearable electronic device 210 may be worn on left hand 110. In some embodiments, wearable electronic device 210 may include a watch, a smart-watch, a wristband, an eyeglass, a piece of clothing and/or the like worn by the user. Wearable electronic device 210 may further include first electrode 230 disposed so as to make contact with the skin of the user.

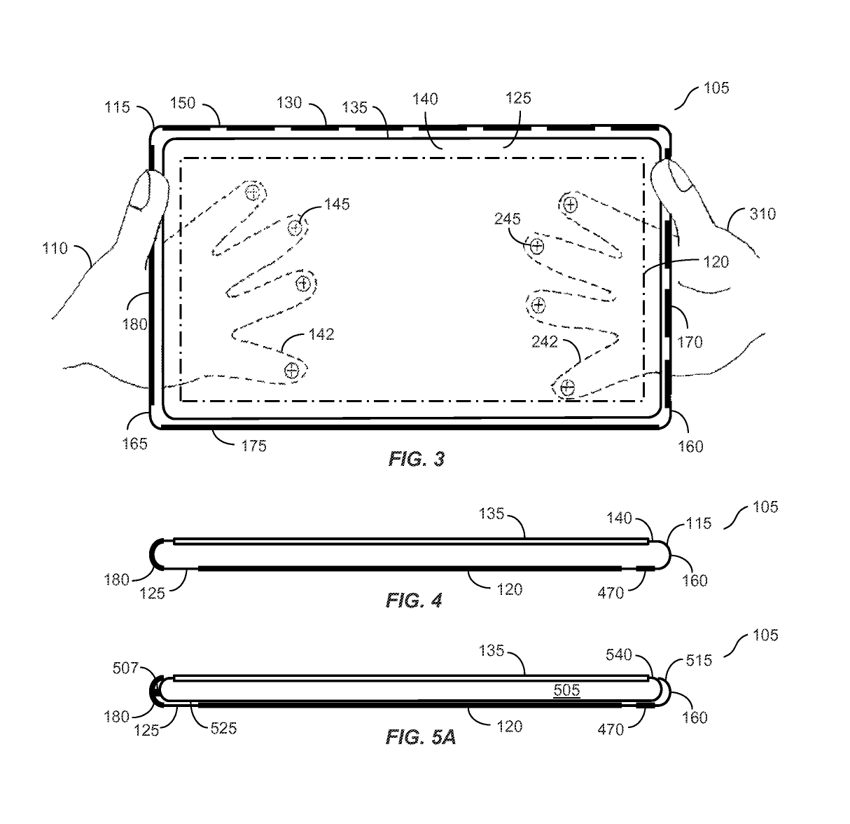

FIG. 3 depicts a simplified perspective view of handheld electronic device 105 depicted in FIG. 1 for electrically detecting left hand 110 and a right hand 310 of the user, in accordance with one embodiment of the present invention. Handheld electronic device 105 may include features similar to handheld electronic device 105 depicted in FIG. 1, with the exception that, whereas FIG. 1 depicts handheld electronic device 105 being operated with display screen 135 in a portrait mode orientation, FIG. 3 depicts handheld electronic device 105 being operated with display screen 135 in a landscape mode orientation. Further, a virtual image 242 of the position of the user's right hand 310 may be displayed on display screen 135 similarly as virtual image 142 of the position of the user's left hand 110 referenced in FIG. 1. In other words, handheld electronic device 105 depicted in FIG. 3 has been rotated clockwise ninety degrees relative its position as depicted in FIG. 1.

In one embodiment, handheld electronic device 105 may include a device orientation sensor that determines which end of handheld electronic device 105 is oriented highest, i.e. “up” to help handheld electronic device 105 establish which end of backside surface 125 is the upper end and thereby defines which end of handheld electronic device 105 may be associated with the left signal. Alternatively, handheld electronic device 105 establish which end of backside surface 125 is the upper end by other commonly used criteria to determine the orientation to display images on display screen 135.

Referring to FIG. 3, the left signal may now be transmitted on fourth electrode 180 because handheld electronic device 105 establishes that first end 150 of backside surface 125 is now the upper end of back side surface 125 in the presently depicted landscape orientation example. Third electrode 170 may be different from fourth electrode 180 and may be adapted to transmit a right signal different from the left signal to right hand 310 of the user different from left hand 110 when the user holds housing 115 with right hand 310. The circuit may be further adapted to detect the right signal when touchpad 120 receives a second input 245 from right hand 310. The right signal may be electrically coupled from the third electrode 170 to touchpad 120 via right hand 310.

In one embodiment, backside surface 125 may include fourth end 165 and third end 160 different from fourth end 165 and substantially parallel to fourth end 165. Fourth electrode 180 may be disposed in proximity to fourth end 165 and third electrode 170 may be disposed in proximity to third end 160. In one embodiment, the circuit is further adapted to determine when touchpad 120 receives left input 145 from a finger of left hand 110 or when touchpad 120 receives a right input 245 from a finger of right hand 310.

FIG. 4 depicts a simplified side view of handheld electronic device 105 depicted in FIG. 1 and FIG. 3, in accordance with one embodiment of the present invention. FIG. 4 depicts features similar to those depicted in FIG. 1 and FIG. 3. FIG. 4 depicts that handheld electronic device 105 may include display screen 135 at front side surface 140 of housing 115. In other words, housing 115 may include display screen 135, touchpad 120, and electrodes 130, 470, 175, 180 in the same unit. Electrode 470 is similar to electrode 170 but disposed at a substantially flat portion of back side surface 125.

In one embodiment, fourth electrode 180 may be preferably disposed so as to overlay a portion of both back side surface 125 and front side surface 140 in proximity to fourth end 165 so as to provide more reliable coupling of the left signal to at least left hand 110 of the user. However, electrodes need not be disposed on both backside surface 125 and front side surface 140. In one embodiment, third electrode 470, analogous to third electrode 170, may be disposed to overlay a substantially flat portion of backside surface 125 to simplify manufacturability and to reduce cost. It is understood that substantially flat portion of backside surface 125 does not preclude backside surface 125 and touchpad 120 from being adapted to flex to the degree that flexible circuit technology allows. In one embodiment, the position of electrodes 130, 470, 175, 180 may be chosen so as to ensure that a connection is made between at least one of the user's hands and the associated electrodes 130, 470, 175, 180 so as to transmit the left and/or right signals from the associated electrodes 130, 470, 175, 180 to the associated left and/or right hand when the user is holding housing 115.

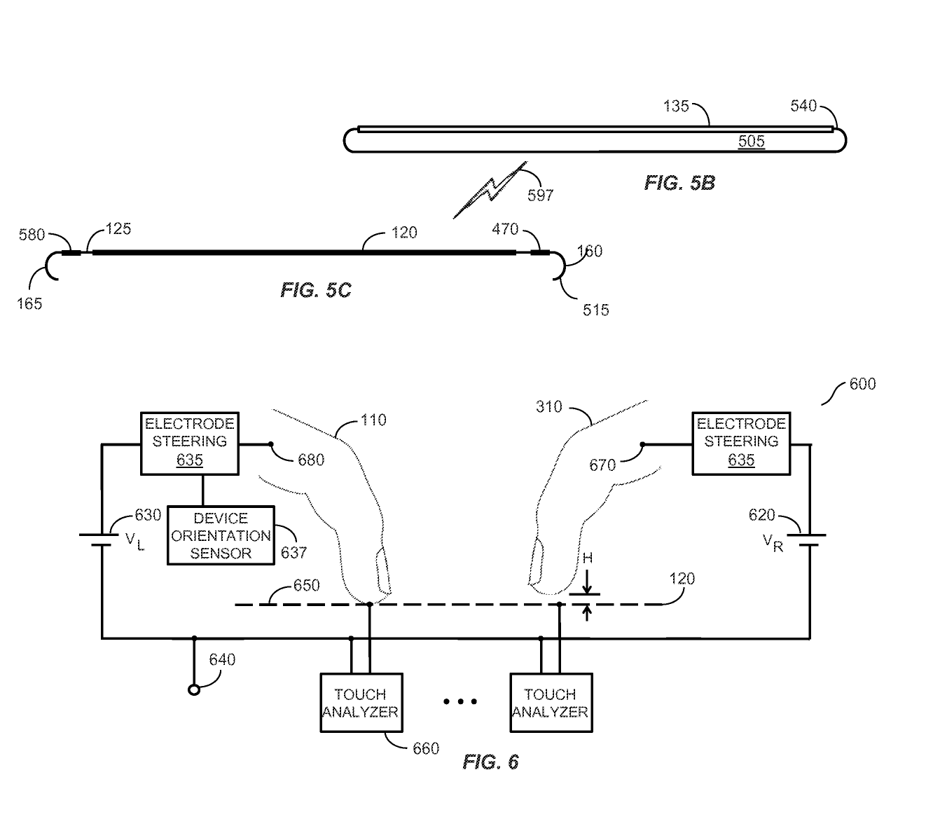

FIG. 5A depicts a simplified side view of the handheld electronic device depicted in FIG. 1 and FIG. 3 and a detachable housing 515, in accordance with one embodiment of the present invention. FIG. 5A depicts features similar to those depicted in FIG. 1 and FIG. 3, except FIG. 5A depicts that a handheld electronic device 505 may include display screen 135 at a front side surface 540 of handheld electronic device 505, and that housing 515 may be adapted to be mechanically detached from handheld electronic device 505. Housing 515 may be adapted to mechanically clip or attach onto handheld electronic device 505 in a manner so as to prevent visual obstruction of display screen 135 when housing 515 is attached continuously to handheld electronic device 505. In other words, housing 515 may include touchpad 120 and electrodes 130, 470, 175, 180 adapted to form a first electronic device, while display screen 135 may be included in a second electronic device different from the first electronic device. Handheld electronic device 505 may be electrically connected to touchpad 120 and electrodes 130, 470, 175, 180 by a wire or a connector 507 or wireless.

FIG. 5B depicts a simplified side view of handheld electronic device 505 depicted in FIG. 5A, in accordance with one embodiment of the present invention. FIG. 5B depicts features similar to those depicted in FIG. 5A, except FIG. 5B depicts that a handheld electronic device 505, which includes display screen 135, may be detached from housing 515.

FIG. 5C depicts a simplified side view of housing 515 depicted in FIG. 5A with the exception that housing 515 may be flipped over 180 degrees, in accordance with one embodiment of the present invention. Housing 515 may include an electrode 580 similar to fourth electrode 180 but disposed at a substantially flat portion of backside surface 125 in proximity to fourth end 165. In other words, FIG. 5A depicts touchpad 120 and electrodes 580 and 470 being disposed facing towards the user. Handheld electronic device 505 may be electrically connected to touchpad 120 and electrodes 130, 470, 175, 580 by wireless network 597.

Embodiments of the present invention may not be limited to handheld and/or wearable electronic devices. Further, housing 515 may be disposed at a location out of the user's field of view or at a location where it would be disadvantageous for the user to look. For example, display screen 135 may be a heads-up display in a moving vehicle, while housing 515 may be an arm/hand rest that includes touchpad 120 that may be located away or detached from display screen 135, but located where touchpad 120 and display screen 135 may be within wired or wireless electronic communication of each other such as within a vehicle. Therefore, a user could use touchpad 120 without taking the eyes off heads-up display screen 135. The user's fingers/hands positions on touchpad 120 may be guided with the assistance of the virtual image of the users hands/fingers being displayed on heads up display screen 135 without looking at touchpad 120. The virtual hands/fingers display system may be assisted with information provided by electrodes 130, 470, 175, 580 either included in housing 115 as depicted in FIG. 5C or included in wearable device 210 depicted in FIG. 2.

Many different types of signal sources may be transmitted by the user's left and/or right hands. FIG. 6 depicts a simplified schematic diagram of a touchpad hand detector circuit 600 included in the device depicted in FIG. 3 including a multitude of time invariant electrical signal sources 620, 630, in accordance with one embodiment of the present invention. Touchpad hand detector circuit 600 may include right time-invariant electrical-signal source 620, V_{R}, coupled to a right electrode 670 via an electrode steering circuit 635. Right electrode 670 is in turn connected to right hand 310. Touchpad hand detector circuit 600 may further include left time-invariant electrical-signal source 630, V_{L}, coupled to a left electrode 680 via the electrode steering circuit 635. Left electrode 680 is connected to left hand 110. V_{L} and V_{R} may be referenced to a common potential 640, e.g. floating local ground. Electrode steering circuit 635 may determine which electrodes on housing 115 receive V_{L} and which receive V_{R} in accordance with device orientation sensor 637 described previously.

In one embodiment, V_{L} and/or V_{R} may be in the range of about 0.1 to 30 VDC and preferably in the range of 0.5 to 5 VDC. The higher end of the voltage range of V_{L} and V_{R} may be easier to detect by touchpad hand detector circuit 600 but may be limited by being sensed as discomfort by the user. The lower end of the voltage range of V_{L} and/or V_{R} may be limited by being harder to detect by touchpad hand detector circuit 600. Further, V_{L} and/or V_{R} may be separated by a minimum voltage difference in the range of about 0.3 to 4.7 VDC and preferably in the range of 0.5 to 2.5 VDC to ensure adequate noise immunity and signal detection.

Touchpad hand detector circuit 600 may further include touchpad 120, which in turn may include a multitude of touch sensors 650, each coupled to a different one of a multitude of touch analyzers 660. Each of the multitude of touch analyzers 660 may be referenced to common potential 640. It is understood that multitude of touch sensors 650 may form an array across a portion of the surface of touchpad 120. In one embodiment, touchpad 120 may be adapted to receive an input when the user touches the touchpad using left hand 110.

In another embodiment, touchpad 120 may be adapted to receive an input when the user hovers a finger of right hand 310 a predetermined distance, H, from the touchpad. It is understood that the users left and/or right hand may hover above touchpad 120 or both hands may touch touchpad 120. In one embodiment, H may be in a range of about 0.1 to 40 mm depending on the characteristics of touchpad 120 and the size of the area of the user's hand that is hovering. For example, a palm of a hand may be detectable up to H=40 mm, while a finger may be detectable up to H=20 mm using the same touchpad. A preferred distance range for hovering a finger may be 0.1 mm<H<20 mm, while a preferred distance range for hovering a palm may be 0.1 mm<H<40 mm.

Different types of touchpad technology may be used for touchpad 120, including capacitive sensing, conductance sensing, resistive sensing, surface acoustic wave sensing, surface capacitance sensing, projected capacitance sensing, strain gauges, optical imaging, dispersive signal technology, acoustic pulse recognition, and bidirectional screen sensing. However, in a preferred embodiment, touchpad sensing technology that does not require high amounts of finger pressure, and touchpad technology that is capable of sensing multiple finger positions at the same time may be used. Such an ability to sense multiple finger positions or gestures at the same time may be referred to as “multitouch” or “multi-touch” sensing technology.

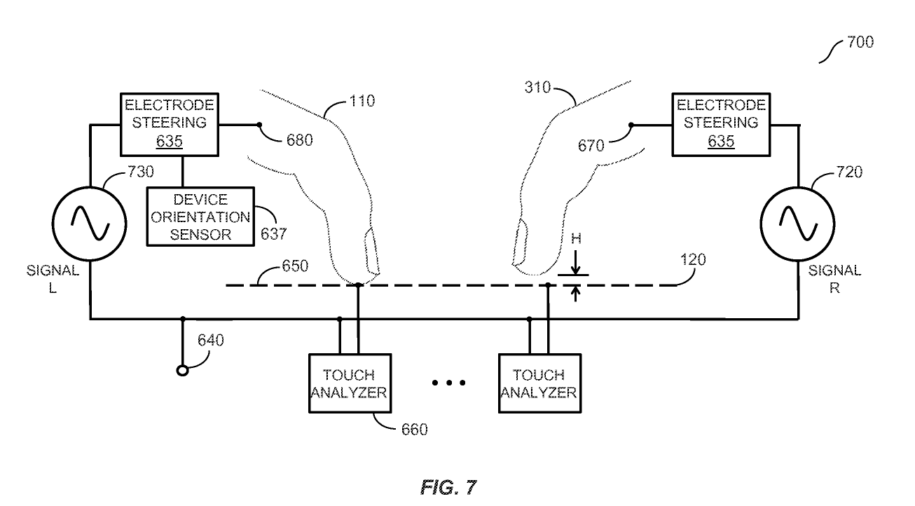

FIG. 7 depicts a simplified schematic diagram of a touchpad hand detector circuit 700 included in the devices depicted in FIG. 3 using a multitude of time variant signal sources 720, 730, in accordance with one embodiment of the present invention. Touchpad hand detector circuit 700 may have similar features as touchpad hand detector circuit 600 depicted in FIG. 6 except touchpad hand detector circuit 700 depicted in FIG. 7 may include time variant signal sources 720, 730, respectively signal R and signal L connected respectively to right hand 310 and left hand 110.

In one embodiment, signal R and/or signal L may be in the frequency range of about 0.5 to 40 MHz and preferably in the range of 5 to 15 MHz because signal propagation within the body is less attenuated in the range of 5 to 15 MHz and because the impedance of electrical contacts is lower in the same range. Voltage amplitude characteristics for time variant signal sources 720, 730 may be similar as for time invariant electrical signal sources 620, 630 described above except time variant signal sources 720, 730 may include equal amplitude and may be separated by a minimum frequency difference preferably in the range of about 2 to 14 MHz.

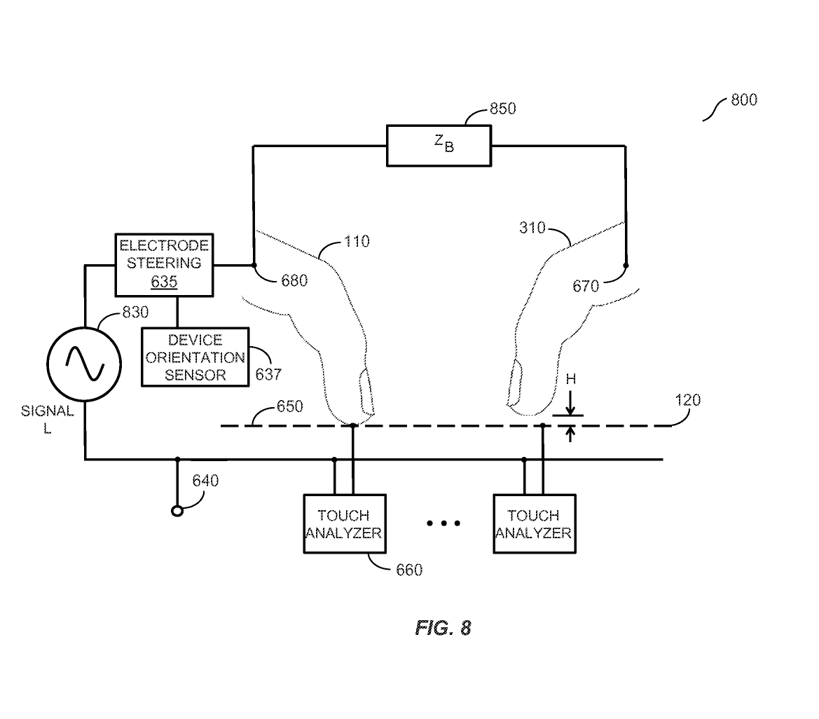

FIG. 8 depicts a simplified schematic diagram of a touchpad hand detector circuit 800 included in the devices depicted in FIG. 3 using a time variant signal source 830, in accordance with one embodiment of the present invention. Touchpad hand detector circuit 800 may have similar features as touchpad hand detector circuit 700 depicted in FIG. 7 except touchpad hand detector circuit 800 depicted in FIG. 8 may include only one time variant signal source 830, signal L. Touchpad hand detector circuit 800 may be further adapted to detect a second signal, signal R including a change in a characteristic of signal L when touchpad 120 receives a second input from right hand 310 when the user holds the housing with right hand 310. Signal R may be electrically coupled from left electrode 680 to touchpad 120 via right hand 310. In other words, signal R may be electrically coupled from left electrode 680 through an impedance 850, Z_{B}, of the user's body between left electrode 680 and right electrode 670. In one embodiment, Z_{B} may be in the range of about 100 ohm to 1 Meg Ohm. For example, signal R at right electrode 670 may include the decreased amplitude of signal L after passing through Z_{B}.

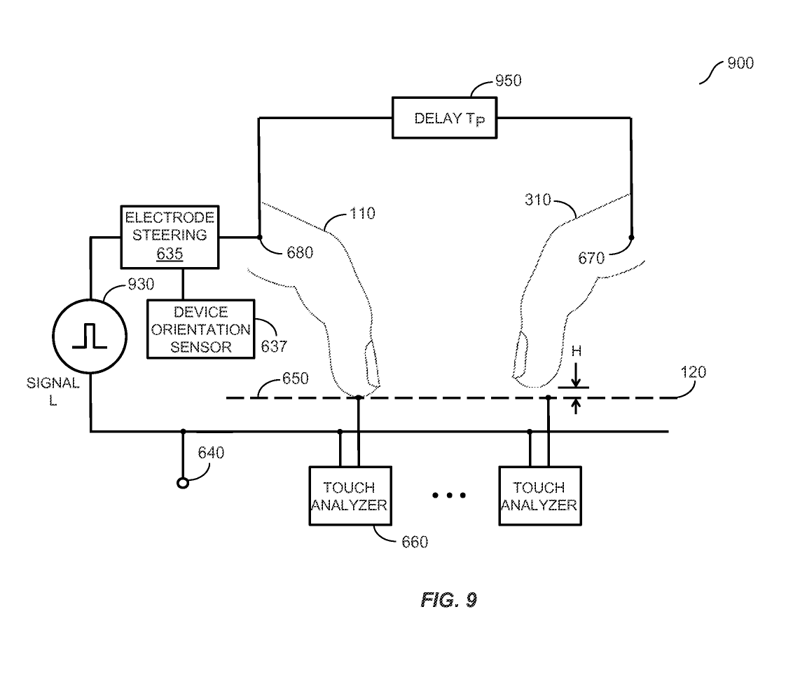

FIG. 9 depicts a simplified schematic diagram of a touchpad hand detector circuit 900 included in the devices depicted in FIG. 3 using a time variant ultrasonic signal source 930, in accordance with one embodiment of the present invention. Touchpad hand detector circuit 900 may have similar features as touchpad hand detector circuit 800 depicted in FIG. 8 except touchpad hand detector circuit 900 depicted in FIG. 9 may include an ultrasonic signal source, signal L 930 instead of an electrical signal source and the change in the characteristic of signal L may include a delay due to sound propagation delay time through the users body between left electrode 680 and right electrode 670. The speed of sound propagation through the user's body may be similar to the speed of sound propagation through water because the body is mostly composed of water. The speed of sound propagation delay may introduce a phase delay T_{P} between signal L at left electrode 680 and signal R at right electrode 670. In one embodiment, T_{P} may be in the range of about 0.1 msec to 10 msec.

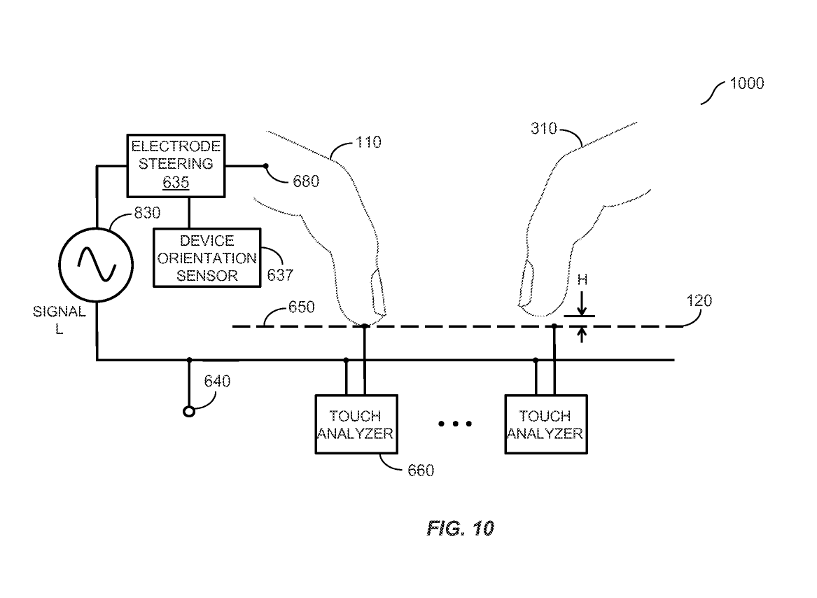

FIG. 10 depicts a simplified schematic diagram of a touchpad hand detector circuit 1000 included in the devices depicted in FIG. 3 using a time variant signal source being used by a first user with left hand 110 and no signal being used by a second user with right hand 310 different than the first user, in accordance with one embodiment of the present invention. Touchpad hand detector circuit 1000 may have similar features as touchpad hand detector circuit 800 depicted in FIG. 8 except touchpad hand detector circuit 1000 depicted in FIG. 10 may include no signal connected to the second user's right hand 310. For example, the first user may be wearing wearable electronic device 210 and the second user may not be wearing wearable electronic device 210, or alternatively, first user may be holding housing 115 to make contact with signal L, while the second user merely places fingers on touchpad 120 without touching any electrodes on housing 115.

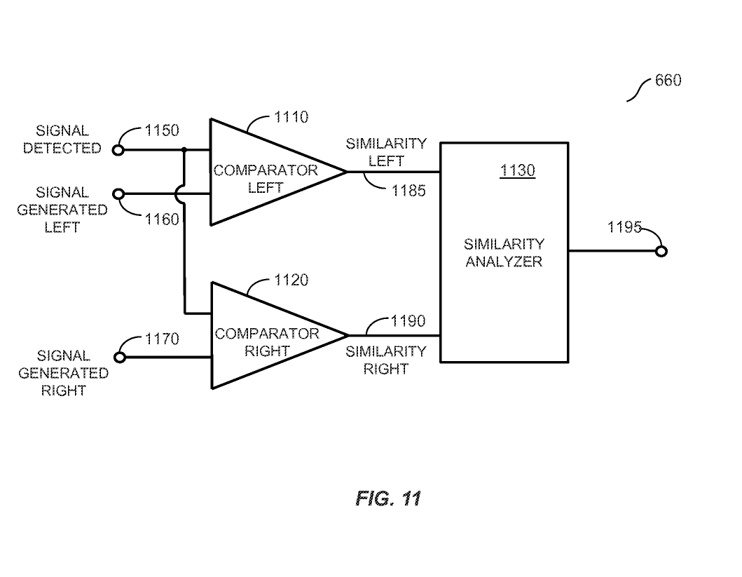

FIG. 11 depicts a simplified schematic diagram of one of the multitude of touch analyzer 660 depicted in FIGS. 6-10, in accordance with one embodiment of the present invention. Touch analyzer 660 may include a comparator left 1110, a comparator right 1120, and a similarity analyzer 1130. Comparator left 1110 and comparator right 1120 may receive signal detected 1150 from an associated one of the multitude of touch sensors 650. Comparator left 1110 may further receive a signal generated left 1160 as a reference signal. Signal generated left 1160 may correspond to left time-invariant electrical-signal source 630, time variant signal source 730, time variant signal source 830, or time variant ultrasonic signal source 930 as depicted respectively in FIGS. 6-8, and/or 9. Comparator right 1120 may receive a signal generated right 1170 as a reference signal. Signal generated right 1170 may correspond to right time-invariant electrical-signal source 620, time variant signal source 720, time variant signal source 830 attenuated through an impedance Z_{B}, or time variant ultrasonic signal source 930 with phase delay T_{P}. In other words, the reference signals to comparator left 1110 and comparator right 1120 are not coupled through left hand 110 or right hand 310.

Comparator left 1110 and comparator right 1120 may generate output signals similarity left 1185 and similarity right 1190 respectively. Similarity left 1185 and similarity right 1190 may be received by similarity analyzer 1130, which determines at the output 1195, which hand, e.g. left hand 110 or right hand 310, may currently be providing input to touchpad 120.

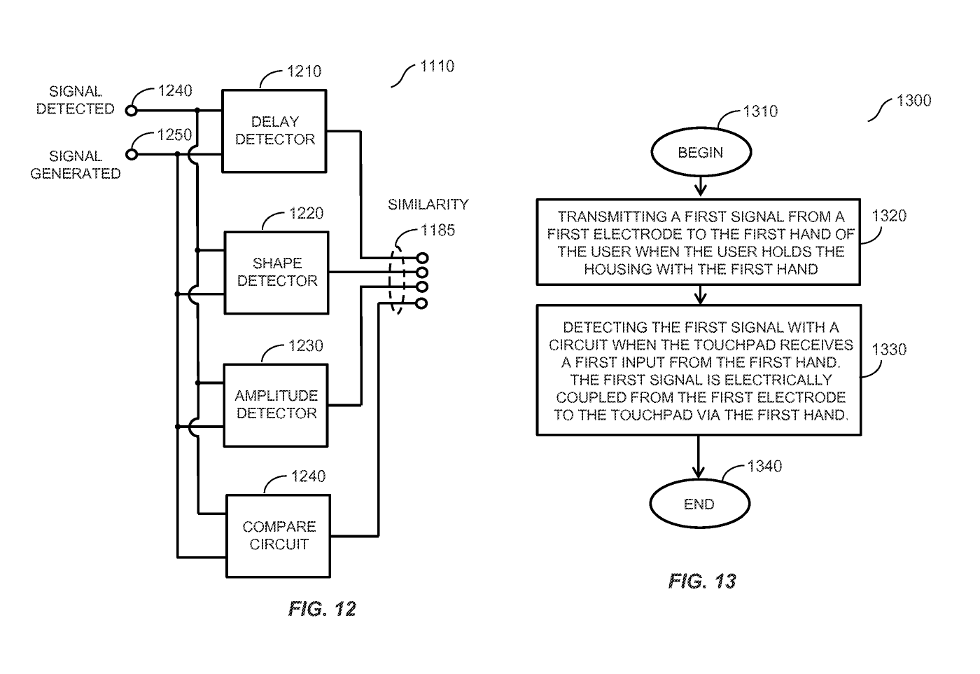

FIG. 12 depicts a simplified schematic diagram of comparator 1110 depicted in FIG. 11, in accordance with one embodiment of the present invention. Comparator 1110 may include a delay detector 1210, a shape detector 1220, and/or an amplitude detector 1230 in any combination according to the generated signal types described in reference to FIGS. 6-10. Comparator 1110 may further include compare circuit 1240. Compare circuit 1240, delay detector 1210, shape detector 1220, and/or amplitude detector 1230 may receive in parallel a signal detected 1240 input and a signal generated 1250 input. Compare circuit 1240, delay detector 1210, shape detector 1220, and/or amplitude detector 1230 may generate in parallel a similarity output 1185.

FIG. 13 depicts a simplified flowchart 1300 for detecting a first hand of a user at an electronic device depicted in FIG. 1, in accordance with one embodiment of the present invention. Referring simultaneously to FIGS. 1, 8 and 13, method 1300 begins at 1310. Method 1300 then includes transmitting at 1320, signal L 830 from a left electrode 680 to left hand 110 of the user when the user holds housing 115 with left hand 110. Next, method 1300 includes detecting signal L 830 with touch analyzer 660 when touchpad 120 receives a first input from left hand 110 at 1330. Signal L 830 may be electrically coupled from left electrode 680 to touchpad 120 via left hand 110.

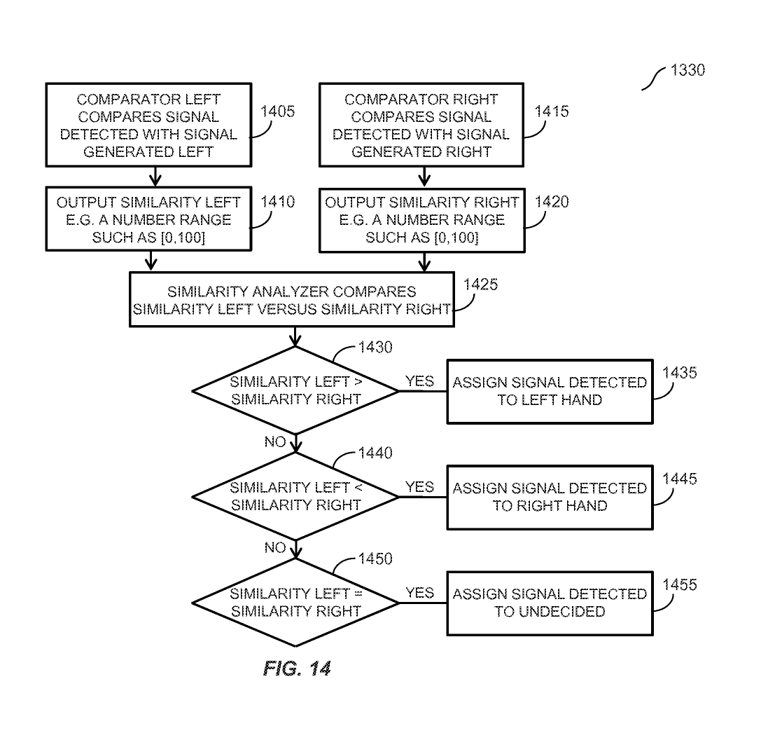

FIG. 14 depicts a simplified flowchart for detecting 1330 the first signal depicted in FIG. 13, in accordance with one embodiment of the present invention. Referring simultaneously to FIGS. 11 and 14, FIG. 14 depicts that comparator left 1110 compares 1405 signal detected 1150 with signal generated left 1160 and that comparator right 1120 compares 1415 signal detected 1150 with signal generated right 1170. Then, comparator left 1110 outputs 1410 similarity left 1185, e.g. a number range such as [0,100] and comparator right 1120 outputs 1420 similarity right 1190, e.g. a number range such as [0,100]. Next similarity analyzer 1130 compares 1425 similarity left 1185 versus similarity right 1190. If similarity left 1185 is greater 1430 than similarity right 1190, then signal detected 1150 may be assigned 1435 to left hand 110. If similarity left 1185 is less 1440 than similarity right 1190, then signal detected 1150 may be assigned 1445 to right hand 310. If similarity left 1185 is equal 1450 to similarity right 1190, then signal detected 1150 may be assigned 1455 to undecided.

Other Touchpad and Screen Locations.

In some embodiments, display screen (e.g., 135) may be located at some distance from touchpad (e.g., 120). Indeed, the display screen and the touch pad may not even be physically connected at all. Rather the touchpad may transmit data pertaining to the user's hand position to a processor, which in turn may then generate the virtual image of the user's hand and display the virtual hand on the display screen, and neither touchpad, processor, or display screen need to be physically connected (although they may be). For example, data pertaining to the user's hand and finger position relative to the touchpad may be transmitted by a wired, wireless, or optical (e.g. infrared) method to the processor. The processor in turn may transmit the virtual image of the user's fingers and hand to the display screen by a wired, wireless, or optical (e.g. infrared) technique. As a result, the user's real hand will be moving close to a touchpad at a different place other than the current display screen. The display screen may thus be in nearly any location, such as on a regular monitor, TV screen, projector screen, or on a virtual heads-up eyeglass display worn by the user (e.g. a device similar to Google Glass).

Touch Pads Including Non-Flat Surfaces.

Although touch pads are often flat and roughly rectangular devices, there is no constraint that the touch pads using embodiments of the present invention be either flat or rectangular. Indeed in some embodiments, there is advantage to employing touch pads that include variably shaped and curved surfaces. Such curved and/or variably shaped touch pads could be then placed on various non-traditional locations, such as on the surface of a ball or cylinder, on the surface of various common devices such as glasses frame stems for virtual heads-up displays such as windshields, eyeglasses, and the like, other wearable computerized devices such as smart watch bands, steering wheels—either for a vehicle or a game interface, joysticks, and the like, and/or, dashboards, instrument panels, and the like.

Touchpad Technology.

In principle, many different types of touchpad technology may be used for device (e.g., 105), including capacitive sensing, conductance sensing, resistive sensing, surface acoustic wave sensing, surface capacitance sensing, projected capacitance sensing, strain gauges, optical imaging, dispersive signal technology, acoustic pulse recognition, pressure sensing and bidirectional screen sensing. However, in one embodiment, touchpad sensing technology that is capable of sensing multiple finger positions at the same time may be used. Such an ability to sense multiple finger positions or gestures at the same time hereinafter also referred to as “multitouch” or “multi-touch” sensing technology. Touchpads are thus distinguished from previous mechanical keyboards or keypads because touchpads are not mechanically actuated, that is, since the surface of a touchpad is substantially rigid and responds to touch instead of a mechanical deflection, the touchpad gives the user substantially no indication that the immediate surface of the touchpad moves where touched, except perhaps for the entire rigid touchpad moving as a result, even with pressure sensitive touchpad technology. Touchpads are further distinguished from previous mechanical keyboards or keypads because the shape and/or location of input keys or buttons on a touchpad are not fixed because the keys and/or buttons are instead displayed on an electronically controlled screen with the flexibility of software control and not limited by fixed mechanical elements located on the device.

One example of a multi-touch touchpad embodying embodiments of the present invention may use a touch sensing device commercially available from Cypress Semiconductor Corporation, San Jose, Calif. and commonly known as the Cypress TrueTouch™ family of products. This family of touchpad products works by projective capacitive technology, and is suited for multi-touch applications. The technology functions by detecting the presence or proximity of a finger to capacitive sensors. Because this touchpad system senses finger proximity, rather than finger pressure, it is well suited to multi-touch applications because, depending upon the tuning of the capacitance detection circuit, various degrees of finger pressure, from light to intense, may be analyzed. Although often used on touch screens, the projective capacitive technology method may function with a broad range of substrates.

The above embodiments of the present invention are illustrative and not limiting. Various alternatives and equivalents are possible. Although, embodiments of the invention has been described with reference to a handheld computerized device by way of an example, it is understood that the disclosed technique is not limited by the type of computerized device or system wherever the device or system may benefit by differentiating between a user's touch on a touchpad for command input and a user's touch on a touchpad for merely holding the device by the touchpad. Although, the disclosed technique has been described with reference to certain user fingers touching the touchpad by way of an example, it is understood that the disclosed technique is not limited by which user fingers are touching the touchpad. Although, the disclosed technique has been described with reference to a touchpad located on the back of a handheld device including a display at the front of the device by way of an example, it is understood that the disclosed technique is not limited by where the touchpad is located. Although, the disclosed technique has been described with reference to a capacitive touchpad used for data entry by way of an example, it is understood that the disclosed technique is not limited by the type of input device. Although, the disclosed technique has been described with reference to a sequence of strong, weak, strong or medium, small, large force applied by a user's finger used for data entry by way of examples, it is understood that the disclosed technique is not limited by those two sequences of forces applied. Other additions, subtractions, or modifications are obvious in view of the present disclosure and are intended to fall within the scope of the appended claims.

What is claimed is:

1. An electronic device comprising:
a housing;
a touchpad at a first surface of the housing;
at least one first electrode adapted to transmit a first signal to a first hand of a user when the user holds the housing with the first hand; and
a circuit adapted to detect the first signal when the touchpad receives a first input from the first hand, wherein the first signal is coupled from the first electrode to the touchpad via the first hand.

2. The electronic device of claim 1, wherein the touchpad is adapted to receive the first input when the user touches the touchpad using the first hand.

3. The electronic device of claim 1, wherein the touchpad is adapted to receive the first input when the user hovers a finger of the first hand at a predetermined distance from the touchpad.

4. The electronic device of claim 1, wherein the circuit is further adapted to detect a second signal including a change in a characteristic of the first signal when the touchpad receives a second input from a second hand when the user holds the housing with the second hand, wherein the second signal is electrically coupled from the first electrode to the touchpad via the second hand.

5. The electronic device of claim 1, wherein the first signal is a time invariant electrical source.

6. The electronic device of claim 1, wherein the first signal is a time variant signal.

7. The electronic device of claim 1, wherein the first surface includes a first end, wherein the first electrode is disposed in proximity to the first end.

8. The electronic device of claim 1, wherein the first electrode is disposed on a wearable device.

9. The electronic device of claim 1 further comprising:
a second electrode different from the first electrode and adapted to transmit a second signal different from the first signal to a second hand of the user different from the first hand when the user holds the housing with the second hand, wherein the circuit is further adapted to detect the second signal when the touchpad receives a second input from the second hand, wherein the second signal is electrically coupled from the second electrode to the touchpad via the second hand.

10. The electronic device of claim 9, wherein the first surface includes a first end and a second end different from the first end and substantially parallel to the first end, wherein the first electrode is disposed in proximity to the first end and the second electrode is disposed in proximity to the second end.

11. The electronic device of claim 9, wherein the circuit is further adapted to determine when the touchpad receives the first input from a finger of the first hand or when the touchpad receives the second input from a finger of the second hand.

12. A method for electrically detecting a first hand of a user at an electronic device including a housing and a touchpad at a first surface of the housing, the method comprising:
transmitting a first signal from at least one first electrode to the first hand of the user when the user holds the housing with the first hand; and
detecting the first signal with a circuit when the touchpad receives a first input from the first hand, wherein the first signal is coupled from the first electrode to the touchpad via the first hand.

13. The method of claim 12, wherein the touchpad receives the first input when the user touches the touchpad using the first hand.

14. The method of claim 12, wherein the touchpad receives the first input when the user hovers a finger of the first hand at a predetermined distance from the touchpad.

15. The method of claim 12, wherein the circuit detects a second signal including a change in a characteristic of the first signal when the touchpad receives a second input from a second hand when the user holds the housing with the second hand, wherein the second signal is electrically coupled from the first electrode to the touchpad via the second hand.

16. The method of claim 12, wherein the first signal is a time invariant voltage.

17. The method of claim 12, wherein the first signal is a time variant signal.

18. The method of claim 12, wherein the first surface includes a first end, wherein the first electrode is disposed in proximity to the first end.

19. The method of claim 12, wherein the first electrode is disposed on a wearable device.

20. The method of claim 12 further comprising:
transmitting a second signal different from the first signal from a second electrode different from the first electrode to a second hand of the user different from the first hand when the user holds the housing with the second hand; and
detecting the second signal with the circuit when the touchpad receives a second input from the second hand, wherein the second signal is electrically coupled from the second electrode to the touchpad via the second hand

21. The method of claim 20, wherein the first surface includes a first end and a second end different from the first end and substantially parallel to the first end, wherein the first electrode is disposed in proximity to the first end and the second electrode is disposed in proximity to the second end.

22. The method of claim 20 further comprising determining with the circuit when the touchpad receives the first input from a finger of the first hand or when the touchpad receives the second input from a finger of the second hand.
